(19) United States
(12) Patent Application Publication
(10) Pub. No.: US 2011/0006494 A1
(43) Pub. Date: Jan. 13, 2011

(54) WHEELCHAIR WITH EXTENDABLE WALKER

(76) Inventor: Evaret Walker, Longview, WA (US)

Correspondence Address: RYLANDER & ASSOCIATES PC, P.O. Box 250, VANCOUVER, WA, 98660, US

(21) Appl. No.: 12/834,880

(22) Filed: Jul. 12, 2010

Related U.S. Application Data
(60) Provisional application No. 61/225,169, filed on Jul. 13, 2009.

(51) Int. Cl. A61G 5/02; A61H 3/04

(52) U.S. Cl. 280/7.17; 135/66

(57) ABSTRACT

The mobility system of an embodiment may be a wheelchair walker system and may include a wheelchair portion and a walker portion that may extend from and/or retract into the wheelchair portion. When the walker portion is substantially retracted within the wheelchair portion, the mobility system may function substantially as a standard and/or unmodified wheelchair. When the walker portion is substantially extended from the wheelchair portion, a user (not illustrated) may utilize the walker portion substantially as a standard and/or unmodified walker.

### CROSS-REFERENCE TO RELATED APPLICATION

This application claims priority to co-pending U.S. Provisional Patent Application Ser. No. 61/225,169 filed Jul. 13, 2009, which is incorporated herein by reference.

### FIELD OF THE INVENTION

The present invention relates a wheelchair. More particularly, the present invention relates to a wheelchair including a walker portion that extends therefrom.

### BACKGROUND

A wheelchair is a wheeled mobility device in which the user sits. The device may be propelled either manually (by turning the wheels by the hand) or via various automated systems. For example, the wheelchair may be propelled by a battery-powered electric motor system. Wheelchairs may be used by people for whom walking is difficult or impossible due to illness (physiological or physical), injury, or disability. Often, wheelchairs are designed to fold or otherwise alter their configuration to offer more compact storage, for example in a trunk of a car, when the wheelchair is not in use.

A walker or walking frame is a tool for disabled or elderly people who need additional support to maintain balance or stability while walking. The basic design consists of a frame that is about waist high, approximately twelve inches deep and slightly wider than the user. Accordingly, walkers may range in size from pediatric to bariatric. Walkers may be height adjustable and may be set at a height that is comfortable for the user, but will allow the user to maintain a slight bend in their arms (e.g., to help maintain circulation in the arms while using the walker). The front two legs of the walker may or may not have wheels attached depending on the strength and abilities of the person using it. It may also be common to see caster wheels or glides on the back legs of a walker with wheels on the front. Like the wheelchair, the walker may include a folding mechanism to decrease their size for storage, for example in the trunk of a car, when the walker is not in use.

### SUMMARY AND ADVANTAGES

The mobility system of an embodiment may be a wheelchair walker system and may include a wheelchair portion and a walker portion that may extend from and/or retract into the .wheelchair portion. When the walker portion is substantially retracted within the wheelchair portion, the mobility system may function substantially as a standard and/or unmodified wheelchair. When the walker portion is substantially extended from the wheelchair portion, a user (not illustrated) may utilize the walker portion substantially as a standard and/or unmodified walker.

The wheelchair system of an embodiment of the present invention presents numerous advantages, including: (1) offers the advantages of a wheelchair and of a walker in a single system without requiring an impaired user to use both; (2) the walker substantially completely retracts into the wheelchair when not in use and does not substantially interfere with the operation of the wheelchair; (3) with the walker retracted, the wheelchair system may fold substantially similar to an unmodified wheelchair for relatively compact storage; (4) allows a user to transition between walking, walking with support, and sitting in the wheelchair more easily; (5) provides a generally wheelchair-bound user the opportunity to transition to a walker more easily than if a detached and/or stand-alone device; (6) provides a generally walker-bound user the opportunity to transition to a wheelchair more easily than if a detached and/or stand alone device; and (7) offers an elegant integrated mobility device that may increase the dignity and confidence with which a user may transport themselves.

Additional advantages of the invention will be set forth in part in the description that follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a mobility system of an embodiment with a walker portion extended therefrom.

FIG. 2 shows the mobility system of an embodiment with the walker portion retracted therein.

FIG. 3 shows the mobility system of an embodiment with the walker portion retracted therein and in a folded configuration.

FIG. 4a shows the scissor joint of the wheelchair portion of an embodiment in an open configuration.

FIG. 4b shows the scissor joint of the wheelchair portion of an embodiment in a semi-open configuration

FIG. 4c shows the scissor joint of the wheelchair portion of an embodiment in a closed configuration

### REFERENCE NUMBERS USED IN DRAWINGS

Turning now descriptively to the drawings, in which similar reference characters denote similar elements throughout the several views, the figures illustrate the wheel cover assembly of an embodiment of the present invention. With regard to the reference numerals used, the following numbering is used throughout the various drawing figures:
10 mobility system
20 wheelchair portion
22 wheelchair back
23 wheelchair handle
24 wheelchair seat
26 wheelchair wheel
28 wheelchair armrest
29 wheelchair armrest vertical strut
30 wheelchair seat frame
32 wheelchair base frame
34 wheelchair base vertical strut
50 walker portion
52 armrest walker extension
54 walker vertical strut
56 seat frame walker extension
58 base frame walker extension
60 caster wheel
70 wheelchair scissor joint
71 wheelchair scissor joint member
72 wheelchair scissor joint pivot

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

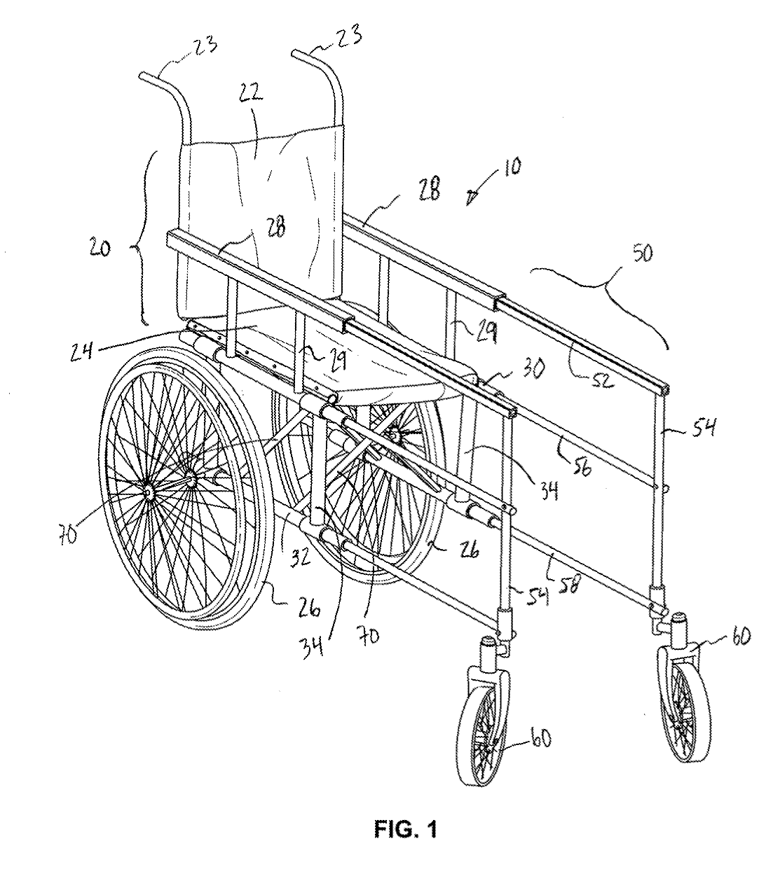

As shown in FIGS. 1-4, a mobility system 10 is provided. Simply stated, the mobility system 10 may be a wheelchair walker system and may include a wheelchair portion 20 and a walker portion 50 that may extend from and/or retract into the wheelchair portion 20. When the walker portion 50 is substantially retracted within the wheelchair portion 20, the mobility system 10 may function substantially as a standard and/or unmodified wheelchair. When the walker portion 50 is substantially extended from the wheelchair portion 20, a user (not illustrated) may utilize the walker portion 50 substantially as a standard and/or unmodified walker. However, the walker portion 50 of an embodiment may remain substantially coupled to the wheelchair portion 20 such that the wheelchair portion 20 may provide added stability to the walker portion 50 and the ability for the user to transition substantially easily between sitting on the wheelchair portion 20 and walking with the walker portion 50. Further, the user may substantially extend the walker portion 50 from the wheelchair portion 20 while they are seated in the wheelchair portion 20 thereby contributing to the ease of transition between sitting on the wheelchair portion 20 and walking with the walker portion 50.

FIG. 1 shows the mobility system 10 of an embodiment with a walker portion 50 retractably extended from the wheelchair portion 20. In an embodiment, the wheelchair portion 20 may include a wheelchair back 22, one or more (in an embodiment two) wheelchair handles 23, a wheelchair seat 24, and two wheelchair wheels 26. Though not illustrated, the wheelchair portion 20 may also include a set of footrests that are foldable or otherwise configurable to deploy and/or retract depending on the user's needs. These components of wheelchair portion 20 may function substantially as they would on a standard and/or unmodified wheelchair.

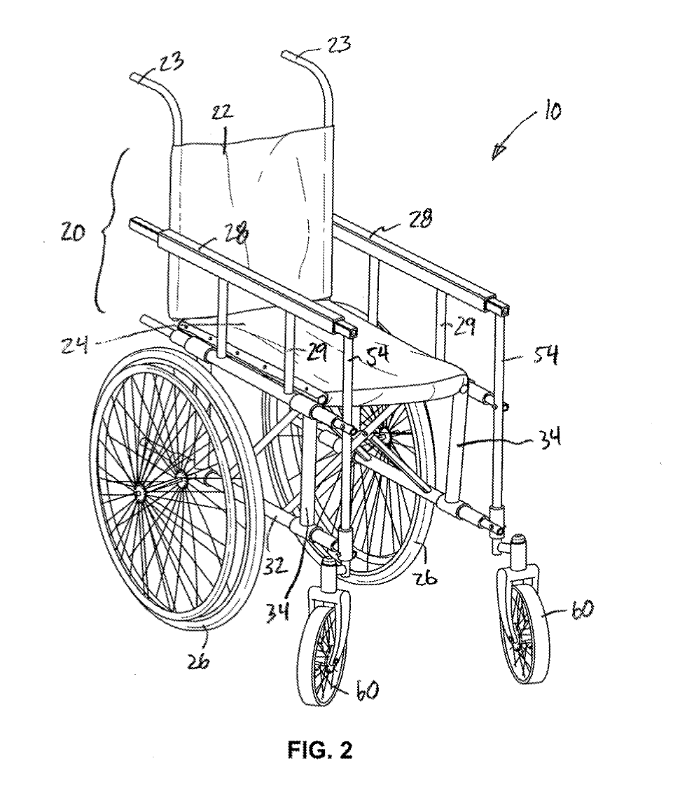

FIG. 1 further illustrates that the wheelchair portion 20 may further include a wheelchair base frame 32, a wheelchair seat frame 30 coupled to the wheelchair base frame 32 with one or more wheelchair base vertical struts 34, and two wheelchair armrests 28 coupled to the wheelchair seat frame 30 with one or more wheelchair armrest vertical struts 29. Unlike their standard and/or unmodified counterparts, the wheelchair base frame 32, wheelchair seat frame 30, and/or wheelchair armrests 28 may be substantially hollow, slotted, and/or otherwise configured to receive and/or include one or more portions of the walker portion 50 when the walker portion 50 is substantially retracted into the wheelchair portion 20 as will be described with reference to FIG. 2.

When extended from wheelchair portion 20, walker portion 50 may include armrest walker extension 52, seat frame walker extension 56, and base frame walker extension 58 extending from each lateral side of the wheelchair portion 20. Each armrest walker extension 52, seat frame walker extension 56, and base frame walker extension 58 may couple to a walker vertical strut 54 substantially at their distal (i.e., away from the wheelchair portion 20) ends. A caster wheel 60 may further couple to each walker vertical strut 54. In an embodiment, the each armrest walker extension 52, seat frame walker extension 56, and base frame walker extension 58 may extend from the wheelchair portion 20 approximately by 1 to 2 times the depth of the wheelchair portion. The extension length of an embodiment may be long enough to define an area between the wheelchair seat 24 and the end of the wheelchair armrest extensions 52 in which a user may walk. The extension length may at the same. time be short enough to substantially ensure the rigidity of at least the walker portion 50 of the mobility system 10 so that a user may apply some and/or most of their weight to the wheelchair armrest extensions 52 without substantially deforming the structure of and/or decreasing the stability of at least the walker portion 50 of an embodiment.

Though not illustrated, the walker portion 50 of an embodiment may further include one or more optional lateral support elements between the two sections (e.g., left and right) of the walker portion 50 to further increase the strength and/or stability of at least the walker portion 50 while retractably extended from the wheelchair portion 20. For example, one or more lateral support elements may detachably engage both walker vertical struts 54 to substantially maintain their lateral separation. Multiple lateral support elements, for example one adjacent to the caster wheels 60 and another adjacent to the armrest walker extension 52 may add further support and/or strength to at least the walker portion 50 of the mobility system 10. When not in use, the one or more lateral support elements may detach from the walker portion 50 or may remain substantially coupled to the walker portion 50 while rotating, swinging, or otherwise moving aside to substantially avoid encumbering a mobility system 10 user. Such modifications and/or additions to the mobility system may be particularly useful if the mobility system 10 is sized and/or configured for a bariatric user and/or for a user who may require a relatively high level of support from the walker portion 50.

FIG. 2 shows the mobility system 10 of an embodiment with the walker portion 50 extendably retracted therein. Each armrest walker extension 52, seat frame walker extension 56, and base frame walker extension 58 may extendably retract into wheelchair portion 20. In an embodiment, when each armrest walker extension 52, seat frame walker extension 56, and base frame walker extension 58 is retracted into the wheelchair portion 20, the wheelchair portion 20 may substantially appear as and operate like a standard and/or unmodified wheelchair.

More specifically, each of the wheelchair armrests 28, the wheelchair seat frames 30 and the wheelchair base frame 32 may be substantially hollow. Further, each may have an inside diameter and/or internal dimension to accept the insertion of the armrest walker extensions 52, seat frame walker extensions 56, and base frame walker extensions 58, respectively, into their interiors. For example, in an embodiment, the wheelchair armrests 28, the wheelchair seat frames 30 and the wheelchair base frame 32 may be formed of hollow tubing that has an approximately 1⅛ inch outside diameter with approximately 1/16 inch wall thickness. Accordingly, the inside diameter of an embodiment is approximately 1.0 inch. The armrest walker extensions 52, seat frame walker extensions 56, and base frame walker extensions 58 may be formed of similarly shaped, yet smaller tubing. For example, the armrest walker extensions 52, seat frame walker extensions 56, and base frame walker extensions 58 may be formed from tubing that has an approximately ⅞ inch outside diameter. Accordingly, the approximately ⅞ inch outside diameter of the armrest walker extensions 52, seat frame walker extensions 56, and base frame walker extensions 58 may fit within the approximately 1.0 inch inside diameter of the wheelchair armrests 28, the wheelchair seat frames 30 and the wheelchair base frame 32.

In an embodiment, the interior of the wheelchair armrests 28, the wheelchair seat frames 30, and the wheelchair base frame 32 as well as the exteriors of the armrest walker extensions 52, seat frame walker extensions 56, and base frame walker extensions 58 may be polished and/or may include a friction-reducing coating. The polished surfaces and/or friction-reducing coating may substantially prevent the components of the walker portion 50 from binding to their corresponding components of the wheelchair portion 20 when the walker portion 50 is extended from and retracted into the wheelchair portion 20.

Alternately or additionally, in an embodiment the armrest walker extensions 52, seat frame walker extensions 56, and/or base frame walker extensions 58 may further include plastic wrapping or coating around at least a portion of their outside diameters. For example, the armrest walker extensions 52, seat frame walker extensions 56, and/or base frame walker extensions 58 may be at least partially wrapped or coated around their outside diameters by a heat shrink tubing. In an embodiment, the thickness of the hear shrink tubing added to the approximately ⅞ inch outside diameter of the armrest walker extensions 52, seat frame walker extensions 56, and/or base frame walker extensions 58 may allow each to more snugly fit within the wheelchair armrests 28, the wheelchair seat frames 30 and the wheelchair base frame 32 respectively (each having an approximately 1.0 inch interior diameter). Though snug, the fit between the portions of the walker portion 50 and the wheelchair portion 20 may nevertheless not bind or snag to prevent the deployment and/or retraction of the walker portion 50.

Further, though not illustrated, at least one locking mechanism may substantially lock the walker portion 50 in an extended and/or retracted configuration depending on the mobility desired by the user. For example, while the walker portion 50 is retracted, the locking mechanism may substantially lock the walker portion 50 to the wheelchair portion 20 so that the walker portion does not inadvertently extend and/or otherwise interfere with the operation of the wheelchair portion 20 as a standard and/or unmodified wheelchair. Likewise, the locking mechanism may substantially lock the walker portion 50 in the extended configuration so that the walker portion 50 does not inadvertently retract and/or the wheelchair portion 20 otherwise interfere with the operation of the walker portion 50 as a standard and/or unmodified walker. In an embodiment, the locking mechanism may include a push pin or lock pin in either the wheelchair portion 20 or the walker portion 50 to engage a locking hole in the opposite portion. In an embodiment, the locking mechanism is a push pin included in at least one seat frame walker extension 56 to engage a hole formed in at least one wheelchair seat frame 30. More specifically, the locking mechanism may be a spring-biased push pin coupled to a portion of the walker portion 50 that inserts into the wheelchair portion 20. The wheelchair portion 20 may include at least two holes or apertures through which the spring biased push pin may protrude to substantially lock the walker portion 50 in a retracted configuration and at least one extended configuration. In an embodiment, the retracted configuration hole or aperture and at least one other hole or aperture are separated by approximately 12.0 inches.

At least one additional locking mechanism, also not illustrated, may substantially prevent the mobility system 10 from folding (e.g., for stowage) when the mobility system 10 is in use as a wheelchair and/or a walker. For example, the locking mechanism may substantially lock the wheelchair portion 20 in an unfolded position. In an embodiment, the locking mechanism may include a push pin or lock pin in the wheelchair portion 20 to engage an adjacent locking hole to substantially lock open the wheelchair portion 20. In an embodiment, the locking mechanism is a lock pin to removably engage at least a hole formed in one wheelchair base vertical strut 34 and at least an adjacent hole formed in one wheelchair scissor joint member 71 to substantially prevent the wheelchair scissor joint member 71 from rotation about and/or translation along the wheelchair base vertical strut 34. In an embodiment, a lock pin and corresponding holes may be included in one or both wheelchair base vertical struts 34 toward the front of the wheelchair portion 20 to improve the accessibility of the one or both lock pins. Though described with reference to one or more wheelchair base vertical struts 34, it is to be understood that the locking mechanism may alternately or additionally substantially prevent the wheelchair scissor joint member 71 from rotation about and/or translation along the wheelchair seat frame 30 and/or the wheelchair base frame 32.

In an alternate embodiment not illustrated, adjacent each wheelchair base vertical strut 24 is an elevator strut. Each elevator strut couples to the wheelchair base frame 32. However, instead of coupling to the wheelchair seat frame 30, the elevator struts couple to either a left or right seat rail (not illustrated) separate from the wheelchair seat frame. Each elevator strut has an adjustable length. For example, when the mobility system is folded, and the wheelchair scissor joint members 71 approach a vertical orientation. Accordingly, the vertical distance between the ends of the wheelchair scissor joint members 71 increases. While the vertical spacing between the wheelchair base frame, wheelchair seat frame 30, and wheelchair armrests remains substantially unaltered, the elevator struts may lengthen to accommodate the scissor joint members 71 and seat rails coupled thereto.

In an embodiment, the elevator struts may be formed substantially as telescoping elevator struts with adjustable lengths. Like the various portions of the walker portion 50 that extend from and retract into portions of the wheelchair portion 20, the elevator struts may include a two piece construction with an outer tube accepting an inner tube. Also like the various portions of the walker portion 50, the smaller diameter inner tube may include a coating and/or surface treatment to generate a snug fit between the inner tube and the outer tube while also mitigating friction wear. For example, in an embodiment the inner tube may include a shrink wrap to generate the snug fit while mitigating friction wear.

To substantially lock the mobility system 10 in a folded or unfolded configuration (e.g., for transportation and/or stowage) in an alternate embodiment, the length of the elevator struts may be locked. More specifically, at least one elevator strut may include a hole or aperture into which a lock pin may be removably inserted and substantially secured. In an embodiment, the hole or aperture may extend substantially entirely through the two sidewalls of the outer tube and the two sidewalls of the inner tube. A lock pin inserted into the hole or aperture may form a sturdy locking mechanism to hold the mobility system 10 in the folded or collapsed configuration while the lock pin inserted onto a second hole or aperture may form a sturdy locking mechanism to hold the mobility system 10 in an unfolded or operational configuration. In an embodiment, one elevator strut includes a lock pin locking mechanism to substantially lock the mobility system 10 in either the folded or unfolded configuration. Accordingly, the user needs only remove and replace one lock pin. Alternately, two or more elevator struts may include locking pin locking mechanisms.

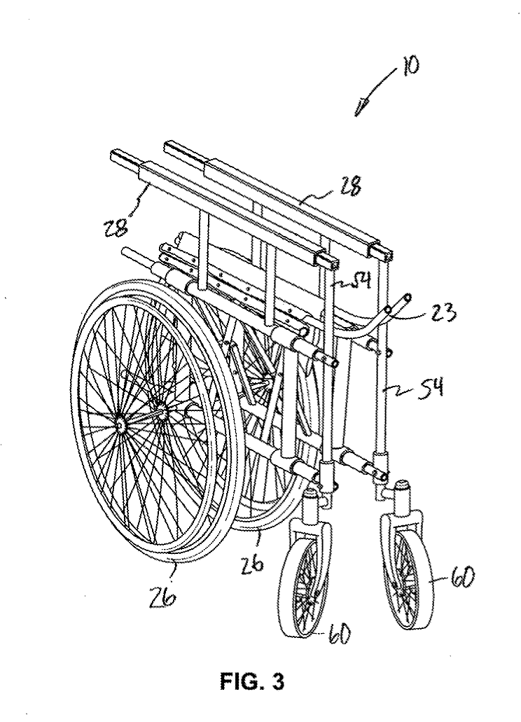

FIG. 3 shows the mobility system 10 of an embodiment with the walker portion 50 extendably retracted into the wheelchair portion 20 therein and in a folded configuration. As introduced above, the retraction of the walker portion 50 within the wheelchair portion 20 may not substantially° interfere with the ability of the mobility system 10 to be folded similar to a standard and/or unmodified wheelchair. Accordingly, while including both the wheelchair and walker features of wheelchair portion 20 and walker portion 50 respectively, the mobility system 10 of an embodiment may nevertheless be folded into a substantially compact configuration for storage and/or transport (or for any other reason for which the compact configuration of mobility system 10 may be desired).

To facilitate the folding and unfolding of the mobility system 10 of an embodiment for storage and/or transport, the one or more scissor joint members 71 may at least in part rotate about the wheelchair seat frame 30 and/or the wheelchair base frame 32 to which the distal ends of the scissor joint members 71 couple. In an embodiment, the distal ends of the scissor joint members 71 may include and/or couple to collars (not illustrated) that fit over and rotate about portions of the wheelchair seat frame 30 and/or the wheelchair base frame 32. In an embodiment, the collars may be configured substantially as hollow cylinders having inside diameters larger than the outside diameters of the portions of the wheelchair seat frame 30 and/or the wheelchair base frame 32 to which the scissor joint members 71 couple. The fit between the portions of the wheelchair seat frame 30 and/or the wheelchair base frame 32 and the collars may be configured so that the collars fit snugly while nevertheless not substantially binding or snagging to prevent the folding and unfolding of the mobility system 10.

As the one or more scissor joint members 71 may at least in part rotate about the wheelchair seat frame 30 and/or the wheelchair base frame 32 to which the distal ends of the scissor joint members 71 couple, the wheelchair seat frame 30 and/or the wheelchair base frame 32 may include one or more features to substantially prevent the scissor joint members 71 from moving or translating along the wheelchair seat frame 30 and/or the wheelchair base frame 32. The one or more features may permit a rotational degree of freedom while substantially preventing additional degrees of freedom.

For example, in an embodiment, the portion of the wheelchair seat frame 30 and/or the wheelchair base frame 32 between two scissor joint members may include a sleeve member (not illustrated) having an outer diameter greater than the inside diameter of the scissor joint member 71 collars. The sleeve members may or may not be substantially rigidly coupled to the wheelchair seat frame 30 and/or the wheelchair base frame 32. The sleeve members of an embodiment may permit the scissor joint member 71 collars to rotate while substantially preventing additional movement and/or translation along the wheelchair seat frame 30 and/or the wheelchair base frame 32. Alternately, the wheelchair seat frame 30 and/or the wheelchair base frame 32 may include one or more hose clamps (not illustrated) or the like coupled thereto to similarly permit the scissor joint member 71 collars to rotate while substantially preventing additional movement and/or translation along the wheelchair seat frame 30 and/or the wheelchair base frame 32.

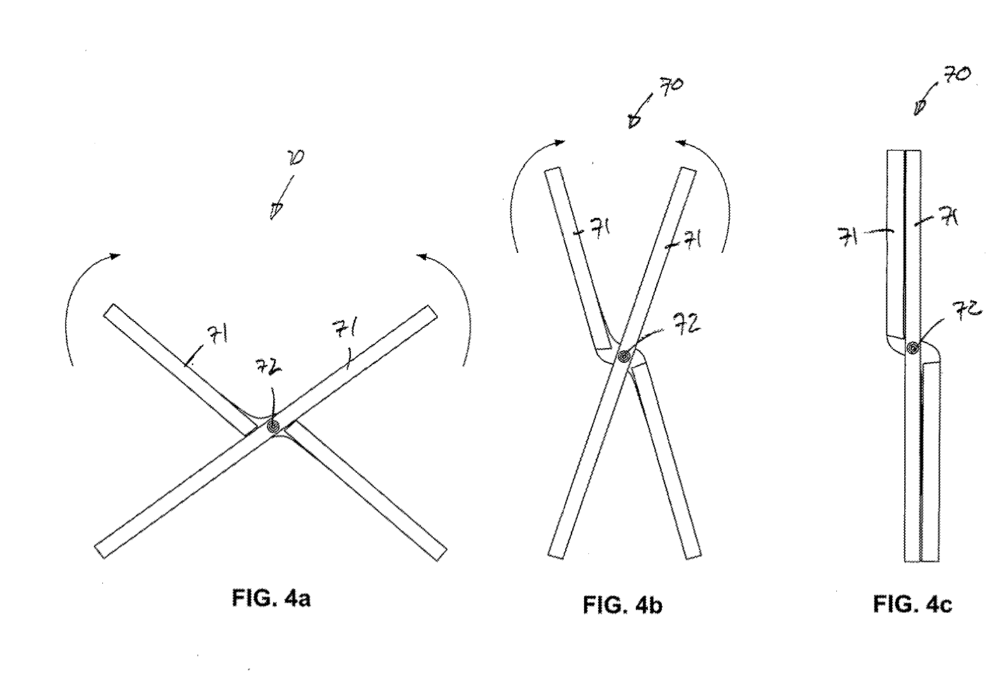

To further increase the ease with which the mobility system 10 may be folded, and to increase the strength and/or stability of mobility system 10 when unfolded, the mobility system 10 of an embodiment may include at least one scissor joint 70 to couple the wheelchair seat frame 30 to the wheelchair base frame 32. For example, FIG. 4a shows the scissor joint 70 of the mobility system 10 of an embodiment in an open configuration (i.e., when the mobility system 10 is unfolded). The scissor joint 70 of an embodiment may include two scissor joint members 71 that couple to and rotate about a scissor joint pivot 72. FIG. 4b shows the scissor joint 70 of the mobility system 10 of an embodiment in a semi-open configuration (i.e., when the mobility system 10 is partially folded/unfolded). FIG. 4c shows the scissor joint 70 of the mobility system 10 of an embodiment in a closed configuration (i.e., when the mobility system 10 of an embodiment is substantially folded). In an embodiment, at least one of the scissor joint members 71 may include a chicane-like bend and/or offset adjacent to the scissor joint pivot 72 so that when scissor joint 70 is in the closed configuration, the scissor joint members 71 may be substantially parallel. Further, in an embodiment the distal ends of the scissor joint members 71 may be substantially in the same plane when the scissor joint 70 is in the closed configuration.

From a folded configuration, the mobility system 10 may be unfolded substantially into a wheelchair. In such a configuration, the walker portion 50 may be extendably retracted within the wheelchair portion 20. To extend the walker portion 50, a user may grasp at least a part of the walker portion (after unlocking a locking mechanism if present) and pull it from the wheelchair portion 20 until it is substantially extended therefrom. Alternately, while seated in the wheelchair portion 20, the user may push the walker portion 50 away from the wheelchair portion until it is substantially extended therefrom. At this point, the user may grasp at least the armrest walker extensions 52 (for example, after standing up from the wheelchair portion 20) to use the mobility system 10 as a walker. Thereafter the user may return to a seated position in wheelchair portion 20 and may retract the walker portion 50 into the wheelchair portion 20 while seated.

As the user may both alter the configuration of the mobility system 10 and transition between the seated and standing positions (e.g., seated to standing and standing to seated) substantially without having to remove themselves from the mobility system 10, set aside the mobility system 10, and/or otherwise substantially break contact with the mobility system 10, the mobility system 10 of an embodiment may further mitigate the likelihood of an accident during what is otherwise a risky transition. For example, when transitioning from a walker to a chair, the user may traditionally set the walker aside often to their left or right, in particular if the chair is adjacent a table or the like such that the user cannot set the walker aside in front of themselves, before sitting down on the chair. Likewise, when transitioning from a chair to a walker, the user may have to stand up first and then search to their left or right for their walker. For both instances, there may be a brief moment during which the user has substantially no support. By coupling the wheelchair portion 20 to the walker portion 50, the mobility system 10 may help the user avoid accidents by keeping both the wheelchair portion 20 and the walker portion 50 substantially within reach at the same time.

Though described as foldable for storage and including an extendible walker portion 50 that may also be retracted, an alternate embodiment may omit either or both features. For example, the mobility system 10 of an alternate embodiment may include a walker portion 50 extending therefrom that may not also retract into the wheelchair portion 20. Though it may not retract into the wheelchair portion, walker portion 50 may be removable from the wheelchair portion 20. Further, the mobility system may not fold or otherwise collapse to improve portability. Such an embodiment may be useful for physical therapy and/or physical rehabilitation and/or in environments (e.g., medical facilities, assisted living facilities) in which the mobility system 10 may be deployed substantially exclusively on site.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A mobility system comprising:
a wheelchair portion; and
a walker portion coupled to the wheelchair portion to retractably extend from the wheelchair portion.

2. The mobility system of claim 1, the wheelchair portion further comprising:
a wheelchair base frame;
a wheelchair seat frame coupled to the wheelchair base frame with at least one scissor joint and at least one wheelchair base vertical strut; and
a pair of wheelchair armrests coupled to the wheelchair seat frame with at least one wheelchair armrest vertical strut per wheelchair armrest;
wherein at least a portion of the wheelchair base frame, a portion of the wheelchair seat frame, and a portion of each wheelchair armrest are configured to retractably accept at least a portion of the walker portion.

3. The mobility system of claim 1, the walker portion further comprising:
a pair of base frame walker extensions;
a pair of seat frame walker extensions;
a pair of armrest walker extensions; and
a pair of walker vertical struts, each one coupled to one base frame walker extension; one seat frame walker extension, and one armrest walker extension.

4. The mobility system of claim 3, at least a portion of the pair of base frame walker extensions, pair of seat frame walker extensions, pair of armrest walker extensions, or a combination thereof further comprising a plastic coating.

5. The mobility system of claim 4, the plastic coating further comprising a shrink wrap coating.

6. The mobility system of claim 2 further comprising at least one walker portion locking mechanism to substantially lock the walker portion to the wheelchair portion while the walker portion is in an extended configuration, a retracted configuration, or a combination thereof.

7. The mobility system of claim 6, the walker portion locking mechanism further comprising at least one push pin locking mechanism included in the walker portion to detachably engage at least one push pin aperture included in the wheelchair portion.

8. The mobility system of claim 2, further comprising at least one wheelchair portion locking mechanism to substantially lock the wheelchair in an open position.

9. The mobility system of claim 8, the wheelchair locking portion further comprising at least one lock pin locking mechanism included in a wheelchair base vertical strut.

10. The mobility system of claim 2, the walker portion further comprising at least one lateral support element to detachably engage a lateral side of the walker portion to another lateral side of the walker portion while the walker portion is substantially extended from the wheelchair portion.

11. A method of improving mobility of a user comprising:
providing a mobility system configured to increase the mobility of the user while seated;
altering the configuration of the mobility system; and
providing the mobility system configured to increase the mobility of the user while standing or walking.

12. The method of improving the mobility of the user of claim 11, the mobility system configured to increase the mobility of the user while seated further comprising the mobility system substantially configured at least in part as a wheelchair.

13. The method of improving the mobility of the user of claim 11, the mobility system configured to increase the mobility of the user while standing or walking further comprising the mobility system substantially configured at least in part as a walker.

14. The method of improving the mobility of the user of claim 11, altering the configuration of the mobility system further comprising reversibly altering the mobility system between a wheelchair configuration and a walker configuration.

15. A method of improving the mobility of a user comprising:
mobilizing, with a mobility system configured in a wheelchair configuration, the user while seated;
mobilizing, with the mobility system configured in a walker configuration, the user while standing or walking; and
reversibly converting the mobility system between the wheelchair configuration and the walker configuration.

16. The method of improving the mobility of the user of claim 15, reversibly converting the mobility system between the wheelchair configuration and the walker configuration further comprising extending a walker portion from the wheelchair portion.

17. The method of improving the mobility of the user of claim 16 further comprising:
unlocking the walker portion a stowed position from the wheelchair portion;
extending the walker portion from the wheelchair portion; and
locking the walker portion in an extended position.

18. The method of improving the mobility of the user of claim 17 further comprising:
unlocking the walker portion from the extended position;
retracting the walker portion into the wheelchair portion; and
locking the walker portion in the stowed position.
